(19) United States
(12) Patent Application Publication
(10) Pub. No.: US 2012/0269514 A1
(43) Pub. Date: Oct. 25, 2012

(54) High Speed IO with Coherent Detection

(75) Inventor: Nikola Nedovic, San Jose, CA (US)

(73) Assignee: FUJITSU LIMITED, Kanagawa (JP)

(21) Appl. No.: 13/093,625

(22) Filed: Apr. 25, 2011

(51) Int. Cl. H04J 14/00

(52) U.S. Cl. 398/66

(57) ABSTRACT

In one embodiment, a first module of a server system modulates a common-source optical signal to generate a modulated optical data signal, transmits the modulated optical data signal to a second module of the server system via an optical link, and the second module demodulates the optical data signal using a coherent detection technique using the common-source optical signal.

### TECHNICAL FIELD

The present disclosure relates generally to coherent optical communication detection within an optical communication system.

### BACKGROUND

A server system generally includes a number of server modules (SMs), one or more chassis-monitoring modules (CMMs), a backplane or midplane, and a number of other modules or components for providing power, input/output (IO or I/O) connectivity, etc. By way of example, a typical backplane is a circuit board that connects several connectors (e.g., of various modules) in parallel to each other so that, for example, each pin of each module is linked to the same relative pin of the other modules forming a communication bus. Whereas modules, such as, for example, SMs, CMMs, line cards, printed circuit boards, and other devices, connect to only one side of a backplane, a midplane generally has modules connected to both sides of the board. Midplanes are commonly used in computer or server systems, especially those connecting blade servers, where server blades may reside on one side of the midplane and other peripheral (power, networking, I/O, etc.) and service modules typically reside on the opposite side of the midplane.

Communication between a module within one server system and a remote node may be accomplished in either the optical or electrical domain, while communication between two modules within a server or server system is typically realized in the electrical domain (e.g., with conducting traces or other electrical connections) via the backplane or midplane. However, all optical server communication may be realized using direct detection, where a transmitter of a module utilizes a local (e.g., on-board) oscillator to generate an optical signal, modulates the optical signal in some way to encode data, then transmits the modulated optical signal over an optical link to a receiver of a designated receiving module. However, in systems using direct detection, the receivers of the modules do not include or utilize local oscillators, and as such, detection and decoding/demodulating of a received optical signal is based solely on the amplitude of the optical signal (which may be as simple as ascertaining the presence or absence of energy) or the amplitude and phase of the optical signal.

Another detection scheme, coherent detection, requires a local oscillator (e.g., a laser) at the receiver, which oscillates at nominally the same frequency as the oscillator at the remote source; that is, the transmitter from which a received optical signal was generated and transmitted. Typically, there may be some wavelength tolerance (and implicitly frequency tolerance) or phase shift between the transmitting and receiving oscillators. Although coherent detection offers better sensitivity, coherent detection is used exclusively in long distance communication applications such as telecommunications due, largely in part, to the costly overhead required to implement the technique. One of the large contributors to this overhead is a complex digital signal processing circuit required to compensate for the slight frequency difference between the remote oscillator at the transmitter and the local oscillator at the receiver.

### BRIEF DESCRIPTION OF THE DRAWINGS

FIG. 1 illustrates a conventional example of a synchronous optical receiver.

FIG. 2 illustrates an example of an optical communication system configured for coherent optical communication detection.

FIG. 3 illustrates an example of a receiver optical-to-electrical demodulation block.

FIG. 4 illustrates an example method for coherent optical communication within a local optical communication system.

### DESCRIPTION OF EXAMPLE EMBODIMENTS

Particular embodiments relate to coherent optical communication within a server system architecture. More particularly, the present disclosure provides examples of a server system architecture that utilizes a common source optical signal for both modulation and demodulation, and which utilizes an optical backplane or midplane to transmit optical signals produced by modulating the common source optical signal, as well as to, in some embodiments, distribute the common source optical signal to the transmitters and receivers of the modules connected to the backplane or midplane.

In contrast to existing optical direct-detection system technology, an optical coherent detection scheme can detect not only an optical signal's amplitude but phase and polarization as well. In coherent detection, a modulated optical input signal is detected using a carrier phase reference optical signal generated at the receiver. With an optical coherent detection system's increased detection capability and spectral efficiency, more data can be transmitted within the same optical bandwidth. Conventionally, implementing a coherent detection system in optical networks (typically involving transmitting optical signals over large distances) requires: 1) a method to stabilize the frequency difference between a remote transmitter and receiver within close tolerances; 2) the capability to minimize or mitigate frequency chirp or other signal inhibiting noise; 3) an availability of an optical mixer to properly combine the signal and the local amplifying light source or local oscillator; and 4) an ability to stabilize the relative state of polarization between the transmitter and the local oscillator.

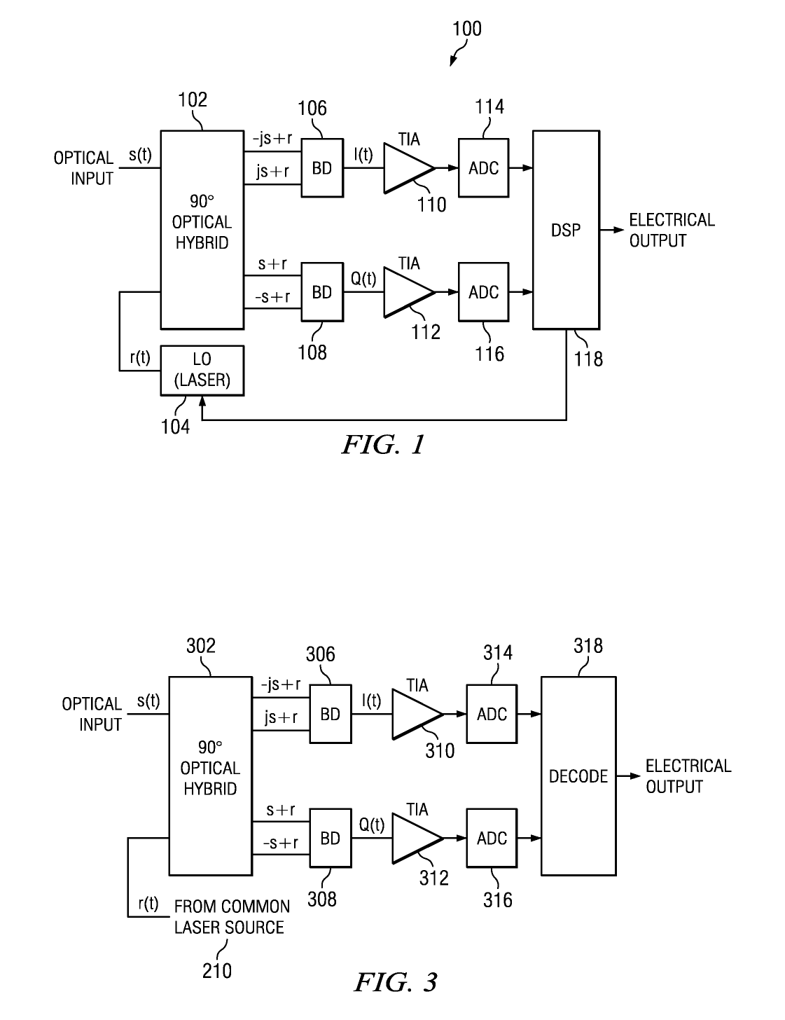

FIG. 1 illustrates a conventional example of a synchronous optical receiver circuit 100 (“receiver 100”) configured for coherent detection for use in long-distance optical communications. Receiver 100 consists of a ninety degree (90°) optical hybrid 102 that combines a received modulated optical input signal s(t) with the optical reference signal r(t) generated by local oscillator (LO) 104, which is typically a frequency-tunable laser. More specifically, a 90° optical hybrid is a six-port device that is used for coherent signal demodulation for either homodyne or heterodyne detection. Optical hybrid 102 mixes the input signal s(t) with four quadratural states associated with the reference signal r(t) in the complex-field space to produce four combinations of the reference signal r(t) generated by LO 104 and the phase-shifted input signal s(t). In the illustrated example, the first two optical combination signals, −js+r and js+r, where “j” is the imaginary unit, are input to a first balanced detector (BD) 106, while the second two optical combination signals, s+r and −s+r, are input to a second BD 108. The levels of the four combination signals are detected by the corresponding BDs 106 and 108, which include photodiodes for converting the optical combination signals into photocurrent. By applying suitable base-band signal processing algorithms, the amplitude and phase of the unknown signal can be determined. BDs 106 and 108 output mixed quadrature signals I(t) and Q(t), respectively, that contain the full information of the phase and amplitude of the input signal s(t). Due to the frequency difference between the optical input signal s(t) and the optical reference signal r(t) generated by LO 104, there exists a frequency beat component. The mixed quadrature signals I(t) and Q(t) are then input to transimpedance amplifiers (TIAs) 110 and 112, respectively. The TIAs 110 and 112 amplify and convert the mixed quadrature signals I(t) and Q(t) into respective analog voltage signals that are then converted to respective digital signals by analog-to-digital converters (ADCs) 114 and 116, respectively. These digital signals are then input to digital signal processing (DSP) block 118 for demodulation to extract the information carried by the input signal s(t). DSP 118 may either detect and compensate for the rotation of the constellation diagram due to the mismatch between the wavelengths (and implicitly frequencies) of the LO (laser) at the remote transmitter which generated and transmitted the optical signal s(t) and the reference signal r(t) generated by LO 104. Alternately, DSP 118 may output a correction signal to phase-lock the LO 104, and hence the reference signal r(t), to the input signal s(t).

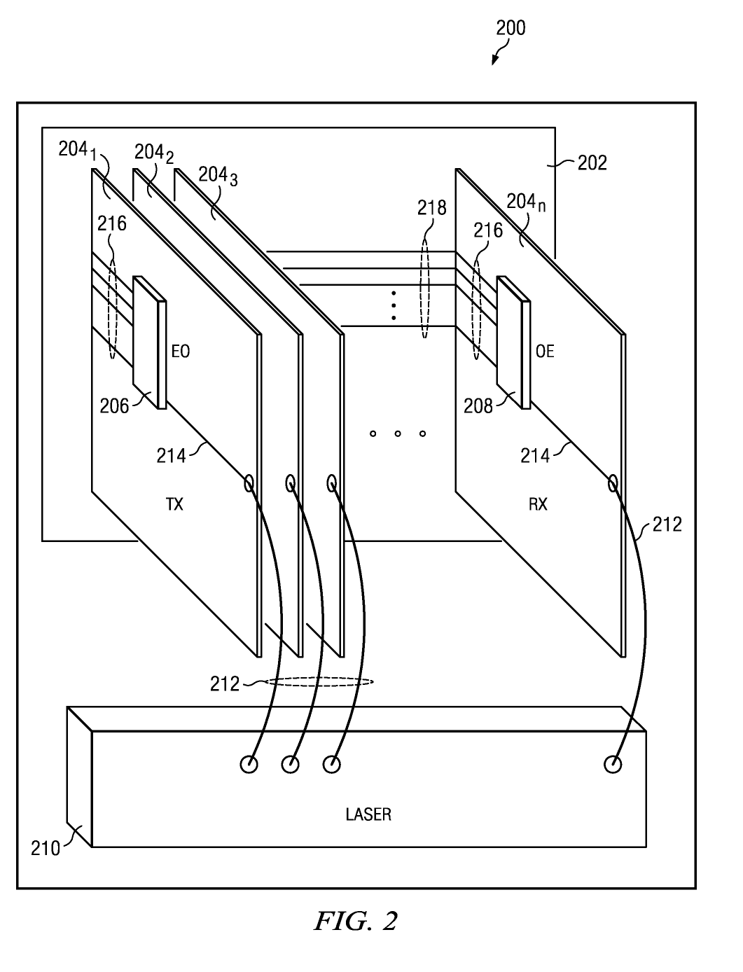

FIG. 2 illustrates an example embodiment of an optical communication system 200 configured for coherent optical communication, and particularly, coherent detection. In particular embodiments, system 200 is a server system or architecture. For example, system 200 may be implemented within a server rack or chassis. In particular embodiments, system 200 may comprise one or more connection board, for example, a backplane or midplane 202, hereinafter referred to as backplane 202 for simplicity, that enables coherent optical communication between a number of modules 204₁, 204₂, 204₃ . . . 204ₙ (collectively referred to as modules 204) connected to backplane 202. Modules 204 may include, for example, line cards, printed circuit boards, server blades, peripheral (power, networking, I/O, etc.) modules, server modules (SMs), chassis-monitoring modules (CMMs), service modules, among other devices or components. Each module 204 may comprise one or more optical interface modules. In particular embodiments, an optical interface module may comprise one or more electrical-to-optical (EO) modulation blocks or circuits 206, as illustrated by module 204₁. In particular embodiments, an optical interface module may comprise one or more optical-to-electrical (OE) demodulation blocks or circuits 208, as illustrated by module 204ₙ.

System 200 further includes an oscillator block or circuit 210. In particular embodiments, oscillator block 210 includes a laser, and even more particularly, a single cavity laser (hereinafter oscillator block 210 is referred to simply as laser 210). In particular embodiments, laser 210 outputs a single coherent continuous wave optical signal (a laser signal) that is split within the block and distributed to each of modules 204. As will be described in more detail below, this common source optical signal is used for all EO modulation at transmitting modules 204 and for all OE demodulation at receiving modules 204, which enables and simplifies coherent detection at the receiving modules 204.

In the illustrated embodiment, the common source optical signal generated by laser 210 is distributed to each of the modules 204 via optical fibers 212 that optically link to on-board waveguides 214 at the edges of the respective modules 204, which then transmit the common source optical signal to the respective EO modulation blocks 206 and OE demodulation blocks 208 of the modules 204. In an alternate embodiment, the common source optical signal generated by laser 210 may be distributed to each of the respective EO modulation blocks 206 and OE demodulation blocks 208 of the modules 204 via optical fibers that link directly to the respective EO modulation blocks 206 and OE demodulation blocks 208. In another alternate embodiment, the common source optical signal generated by laser 210 may be distributed to each of the respective EO modulation blocks 206 and OE demodulation blocks 208 of the modules 204 via one or more dedicated optical power lines (e.g., waveguides) on or within the backplane 202 that originate at laser 210 and optically connect to waveguides on respective modules 204 that then transmit the common source optical signal to the respective EO modulation blocks 206 and OE demodulation blocks 208.

In particular embodiments, the EO modulation blocks 206 and OE demodulation blocks 208 of respective transmitting and receiving modules 204 transmit and receive modulated optical signals, respectively, via on-board waveguides 216, which are optically connected to corresponding backplane waveguides 218 on or within backplane 202. For example, when module 204₁ needs to communicate data to module 204ₙ, the EO modulation block 206 of module 204₁ modulates the common source optical signal received from laser 210 via a corresponding one of the optical fibers 212 and respective waveguide 214 (or via one of the other common source optical signal distribution techniques described above) to encode data. EO modulation block 206 transmits the modulated optical signal to the OE demodulation block 208 of module 204ₙ via a designated one of the on-board waveguides 216 on module 204₁, through a corresponding one of the backplane waveguides 218, and subsequently to the respective one of the on-board waveguides 216 on module 204ₙ. The OE demodulation block 208 of module 204ₙ then demodulates the modulated optical signal received from module 204₁ using the common source optical signal received from laser 210 via a corresponding one of the optical fibers 212 and respective waveguide 214 (or via one of the other common source optical signal distribution techniques described above) as a reference signal to demodulate and decode the data. In this way, coherent detection is achieved without the use of individual oscillators as each of the EO modulation blocks 206 and OE demodulation blocks 208 receives the common source optical signal generated and distributed by laser 210. Furthermore, the EO modulation blocks 206 may be configured to use any suitable modulation technique, such as, for example, phase-shift keying (PSK), differential-quadrature PSK (DQPSK), quadrature amplitude modulation (QAM), among other suitable modulation techniques.

The use of the common light source (laser 210) for each of the EO modulation blocks 206 and OE demodulation blocks 208 ensures that the optical signals modulated and transmitted within system 200 share the same frequency as the reference optical signals used to demodulate the received modulated optical signals with only a phase offset due to the different optical path lengths and noise. In particular embodiments, the phase offset may be eliminated or made moot using a differential modulation scheme such as DQPSK. In an alternate embodiment, an optical delay locked loop (ODLL) may be used to eliminate the phase offset. Additionally, the use of the common light source practically eliminates the issue of light polarization, which is typical in long-distance coherent detection systems, as the only polarization shift from the common source optical signal occurs on very short (e.g., less than one meter) optical fibers or waveguides.

In other embodiments, one or more optical links between a transmitting module and a receiving module may comprise one or more optical fiber cables. For example, the transmitting module may be part of a first rack-mount server within a server rack, and the receiving module may be part of a second rack-mount server within the same server rack, and the user of a common light source for each of EO modulation blocks of the transmitting module and each of OE demodulation blocks of the receiving module share can ensure coherent modulation and demodulation for optical communication between the transmitting module and the receiving module.

Furthermore, the embodiments described herein do not limit or restrict the implementation details of the EO modulation and OE demodulation blocks 206 and 208. For example, the OE demodulation block 208 may be implemented with a 90° shifter and a standard IQ demodulator configured to receive a multi-bit-per-symbol modulated optical signal (e.g., 16-QAM) from a transmitting modules 204. As another example, an ODLL may be used to demodulate the phase of the received optical signal. Moreover, various embodiments may be used with either discrete optical components or integrated photonics (e.g., silicon photonics). Additionally, various embodiments may be generalized to use wavelength division multiplexing (WDM) by providing several wavelengths (e.g., several lasers generating several respective common source optical signals of different wavelengths) for improved interconnect density.

FIG. 3 illustrates an example of an OE demodulation block 208. In particular embodiments, OE demodulation block includes a 90° optical hybrid 302 that combines a received modulated optical input signal s(t) (produced by modulating the common source optical signal generated by laser 210) with the optical reference signal r(t), which is the common source optical signal generated by laser 210. In one embodiment, optical hybrid 302 mixes the input signal s(t) with four quadratural states associated with the reference signal r(t) in the complex-field space to produce four combinations of the reference signal r(t) and the phase-shifted input signal s(t). In the illustrated example, the first two optical combination signals, −js+r and js+r, are input to a first balanced detector (BD) 306, while the second two optical combination signals, s+r and −s+r, are input to a second BD 308. The levels of the four combination signals are detected by the corresponding BDs 306 and 308, which include photodiodes for converting the optical combination signals into photocurrent. BDs 306 and 308 output mixed quadrature signals I(t) and Q(t), respectively, which are in baseband, as the communication is guaranteed to be homodyne by virtue of using the common light source (laser 210), and which contain the full information of the phase and amplitude of the input signal s(t). The mixed quadrature signals I(t) and Q(t) are then input to transimpedance amplifiers (TIAs) 310 and 312, respectively. The TIAs 310 and 312 amplify and convert the mixed quadrature signals I(t) and Q(t) into respective analog voltage signals that are then converted to respective digital signals by analog-to-digital converters (ADCs) 314 and 316, respectively. In an example embodiment, these digital signals are then input to decoder block 318 for demodulation/decoding to extract the information carried by the input signal s(t). In particular embodiments, a simple decoder 318 may be used, depending on the modulation scheme employed by EO modulation block 206 to obtain the electrical output data. For example, if 16-QAM is used, the mixed quadrature signals I(t) and Q(t) already contain the decoded transmitted bits, and thus, the ADCs 314 and 316 have two bits (three slice levels) each, and a decoder is not needed.

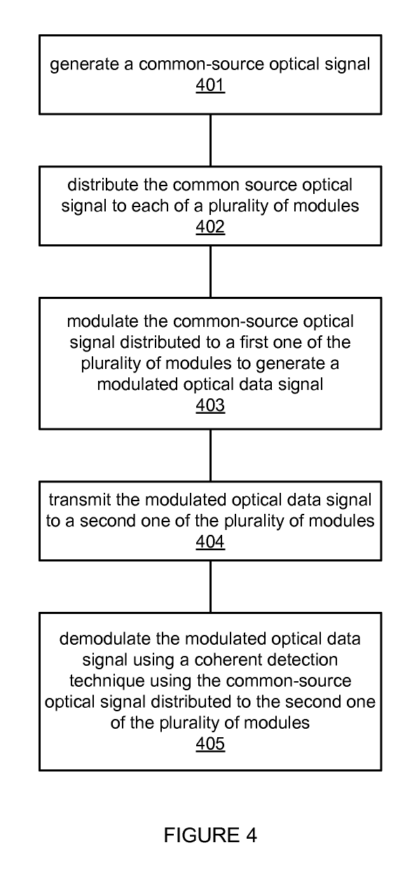

FIG. 4 illustrates an example method for coherent optical communication within a local optical communication. In particular embodiments, a laser may generate a common-source optical signal (401). In particular embodiments, a plurality of a first optical communication links may distribute the common-source optical signal to each of a plurality of modules within a local optical systems (402). In particular embodiments, each of the plurality of modules may comprise one or more optical interface modules, wherein the one or more optical interface modules may be optically connected to respective optical interface modules of other modules of the plurality of modules via one or more respective second optical communication links. For example, a local optical communication system can be a server system comprising multiple modules or boards, a blade server system, or a server rack comprising multiple rack-mount servers. As illustrated in the example system of FIG. 2, a laser 210 may distribute a common-source optical signal to modules 204₁, 204₂, 204₃, . . . , and 204ₙ via a first optical communication links 212 and 214, and the modules 204₁, 204₂, 204₃, . . . , and 204ₙ may be connected to each other via a second optical communication links 216 and 218. In particular embodiments, an optical interface module (e.g., 205 of FIG. 2) of a first one of the plurality of modules may modulate the common-source optical signal to generate a modulated optical data signal (430). In particular embodiments, the optical interface module of the first one of the plurality of modules may transmit the modulated optical data signal via one of the second optical communication links to an optical interface module (e.g., 208 of FIG. 2) of a second one of the plurality of modules (404). In particular embodiments, the optical interface module of the second one of the plurality of modules may demodulate the modulated optical data signal using a coherent detection technique using the common-source optical signal distributed to the second one of the plurality of modules (405).

In conclusion, the described embodiments (and variations thereof) enable coherent communication detection over optical backplanes or midplanes improving sensitivity and allowing the coding of multiple bits per symbol, and consequently, higher throughput. The described embodiments also eliminate the need for directly modulated light sources (typically vertical cavity surface emitting lasers (VCSELs)) that are otherwise typically used in the server modules, which are, and expected to remain, a major reliability and speed bottleneck in high speed optical IO.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

As used herein, “or” may imply “and” as well as “or;” that is, “or” does not necessarily preclude “and,” unless explicitly stated or implicitly implied.

1. A method comprising:
generating, by a laser, a common-source optical signal;
distributing, by a plurality of first optical communication links, the common-source optical signal to each of a plurality of modules within a local optical communication system, each of the plurality of modules comprising one or more optical interface modules, wherein the one or more optical interface modules are optically connected to respective optical interface modules of other modules of the plurality of modules via one or more respective second optical communication links;
modulating, by an optical interface module of a first one of the plurality of modules, the common-source optical signal distributed to the first one of the plurality of modules to generate a modulated optical data signal;
transmitting, by the optical interface module of the first one of the plurality of modules, the modulated optical data signal via one of the second optical communication links to an optical interface module of a second one of the plurality of modules; and
demodulating, by the optical interface module of the second one of the plurality of modules, the modulated optical data signal using a coherent detection technique using the common-source optical signal distributed to the second one of the plurality of modules.

2. The method of claim 1, wherein the optical interface module of the first one of the plurality of modules comprises:
an electrical-to-optical (EO) modulation circuit modulating the common-source optical to a modulated optical data signal

3. The method of claim 1, wherein:
the optical interface module of the second one of the plurality of modules comprises an optical-to-electrical (OE) demodulation circuit; and
demodulating by the OE demodulation circuit the modulated optical data signal using a coherent detection technique using the common-source optical signal distributed to the second one of the plurality of modules.

4. The method of claim 1, wherein each of the plurality of the first optical communication link may comprise an optical fiber cable connecting the laser and a respective optical interface module.

5. The method of claim 1, wherein each of the plurality of the first optical communication link may comprise an optical fiber cable connecting the laser and a respective module and a optical waveguide disposed on the respective module connecting the optical fiber to one or more optical interface modules of the respective module.

6. The method of claim 1, wherein each of the second optical links may comprise a fiber optical cable.

7. The method of claim 1, wherein the local optical communication system further comprises a connection board connecting the plurality of modules.

8. The method of claim 7 wherein the connection board may comprise a back plane.

9. The method of claim 7, wherein the connection board may comprise a mid-plane.

10. The method of claim 7, wherein each of the plurality of the first optical communication links may comprise an optical fiber cable connecting the laser and a first waveguide disposed on the connection board, and a second waveguide disposed on a respective module connecting the first waveguide of one or more optical interface modules of the respective module.

11. The method of claim 7, wherein each of the second optical links may comprise a first waveguide disposed on a first module connecting an optical interface module of the first module, a second waveguide disposed on the connection board connecting the first waveguide and a second module, and a third waveguide connecting the second waveguide and an optical interface module of the second module.

12. The method of claim 1, wherein the laser comprises a single cavity laser.

13. The method of claim 3, wherein demodulating by the OE demodulation circuit the modulated optical data signal using a coherent detection technique using the common-source optical signal distributed to the second one of the plurality of modules comprises:
combining, by the OE block, the modulated data signal with four quadratural states associated with the optical reference signal in the complex-field space to produce first, second, third, and fourth combination signals, respectively;
detecting, by a first balanced detector, the first and second combination signals to generate a first mixed quadrature signal; and
detecting, by a second balanced detector, the third and fourth combination signals to generate a second mixed quadrature signal.

14. The method of claim 13, further comprising:
amplifying and converting, by a first transimpedance amplifier (TIA), the first mixed quadrature signal to produce a first analog voltage signal;
amplifying and converting, by a second TIA, the second mixed quadrature signal to produce a second analog voltage signal;
converting, by a first analog-to-digital converter (ADC), the first analog voltage signal to produce a first digital signal;
converting, by a second ADC, the second analog voltage signal to produce a second digital signal; and decoding the first and second digital signals.

15. The method of claim 1, wherein:
the local optical communication system further comprises one or more other lasers each of which is configured to generate a corresponding common source optical signal having a wavelength that is different from the wavelengths of the other ones of the common source optical signals; and
each of one or more of the common source optical signals is distributed to each of one or more of the plurality of modules.

16. A local optical communication system, comprising:
a laser configured to generate a common-source optical signal;
a plurality of modules wherein each of the plurality of modules comprising one or more optical interface modules, wherein each of the plurality of modules are optically connected to respective optical interface modules of other modules of the plurality of modules via one or more respective second optical communication links; and
a plurality of first optical communication links configured to distribute the common-source optical signal to each of a plurality of modules, wherein:
an optical interface module of a first one of the plurality of modules being configured to modulate the common-source optical signal distributed to the first one of the plurality of modules to generate a modulated optical data signal;
the optical interface module of the first one of the plurality of modules being configured to transmit the modulated optical data signal via one of the second optical communication links to an optical interface module of a second one of the plurality of modules; and
the optical interface module of the second one of the plurality of modules being configured to demodulate the modulated optical data signal using a coherent detection technique using the common-source optical signal distributed to the second one of the plurality of modules.

17. The system of claim 16, wherein the optical interface module of the first one of the plurality of modules comprises:
an electrical-to-optical (EO) modulation circuit modulating the common-source optical to a modulated optical data signal

18. The system of claim 16, wherein:
the optical interface module of the second one of the plurality of modules comprises an optical-to-electrical (OE) demodulation circuit; and
demodulating by the OE demodulation circuit the modulated optical data signal using a coherent detection technique using the common-source optical signal distributed to the second one of the plurality of modules.

19. The system of claim 16, wherein each of the plurality of the first optical communication link may comprise an optical fiber cable connecting the laser and a respective optical interface module.

20. The system of claim 16, wherein each of the plurality of the first optical communication link may comprise an optical fiber cable connecting the laser and a respective module and a optical waveguide disposed on the respective module connecting the optical fiber to one or more optical interface modules of the respective module.

21. The system of claim 16, wherein each of the second optical links may comprise a fiber optical cable.

22. The system of claim 16, further comprising a connection board connecting the plurality of modules.

23. The system of claim 22, wherein the connection board may comprise a back plane.

24. The system of claim 22, wherein the connection board may comprise a mid-plane.

25. The system of claim 22, wherein each of the plurality of the first optical communication links may comprise an optical fiber cable connecting the laser and a first waveguide disposed on the connection board, and a second waveguide disposed on a respective module connecting the first waveguide of one or more optical interface modules of the respective module.

26. The system of claim 22, wherein each of the second optical links may comprise a first waveguide disposed on a first module connecting an optical interface module of the first module, a second waveguide disposed on the connection board connecting the first waveguide and a second module, and a third waveguide connecting the second waveguide and an optical interface module of the second module.

27. The system of claim 16, wherein the laser comprises a single cavity laser.

28. The system of claim 18, wherein demodulating by the OE demodulation circuit the modulated optical data signal using a coherent detection technique using the common-source optical signal distributed to the second one of the plurality of modules comprises:
combining, by the OE block, the modulated data signal with four quadratural states associated with the optical reference signal in the complex-field space to produce first, second, third, and fourth combination signals, respectively;
detecting, by a first balanced detector, the first and second combination signals to generate a first mixed quadrature signal; and
detecting, by a second balanced detector, the third and fourth combination signals to generate a second mixed quadrature signal.

29. The system of claim 28, further comprising:
amplifying and converting, by a first transimpedance amplifier (TIA), the first mixed quadrature signal to produce a first analog voltage signal;
amplifying and converting, by a second TIA, the second mixed quadrature signal to produce a second analog voltage signal;
converting, by a first analog-to-digital converter (ADC), the first analog voltage signal to produce a first digital signal;
converting, by a second ADC, the second analog voltage signal to produce a second digital signal; and
decoding the first and second digital signals.

30. The system of claim 16, further comprising:
one or more other lasers each of which is configured to generate a corresponding common source optical signal having a wavelength that is different from the wavelengths of the other ones of the common source optical signals; and
each of one or more of the common source optical signals is distributed to each of one or more of the plurality of modules.

31. A system comprising:
means for generating a common-source optical signal;
means for distributing the common-source optical signal to each of a plurality of modules within a local optical communication system, each of the plurality of modules comprising one or more optical interface modules, wherein the one or more optical interface modules are optically connected to respective optical interface modules of other modules of the plurality of modules via one or more respective second optical communication links;
means for modulating the common-source optical signal distributed to a first one of the plurality of modules to generate a modulated optical data signal;
means for transmitting the modulated optical data signal via one of the second optical communication links to an optical interface module of a second one of the plurality of modules; and
means for demodulating the modulated optical data signal using a coherent detection technique using the common-source optical signal distributed to the second one of the plurality of modules.
